(19) United States
(12) Patent Application Publication
(10) Pub. No.: US 2022/0132810 A1
(43) Pub. Date: May 5, 2022

(54) BIRD FLUID FEEDER DEVICE

(71) Applicant: Yaron Levite, Raanana (IL)

(72) Inventor: Yaron Levite, Raanana (IL)

(21) Appl. No.: 17/336,373

(22) Filed: Jun. 2, 2021

Related U.S. Application Data
(60) Provisional application No. 63/108,595, filed on Nov. 2, 2020.

(51) Int. Cl. A01K 39/02; F16B 47/00

(52) U.S. Cl. CPC A01K 39/0206; F16B 47/00

(57) ABSTRACT

A bird fluid feeder device may include a storage bottle having a bottle cavity and a bottle base, and a liquid tray having a tray support wall and a feed cavity. A base container may be removably coupled to the liquid tray, the base container having a pass-through aperture and a container wall. The container wall may cover the feed cavity, and the bottle base may be received in the pass-through aperture and removably coupled to the tray support wall. At least one container aperture may be disposed in the container wall, and the container apertures may enable fluid communication through the container wall to the feed cavity. The storage bottle, base container, and liquid tray may be supported by a holder bracket having a first upper support arm for contacting the storage bottle and by a lower support arm contacting the liquid tray.

### CROSS REFERENCE TO RELATED APPLICATIONS

This application claims priority to and the benefit of the filing date of U.S. Provisional Application No. 63/108,595, filed on Nov. 2, 2020, entitled “Fluid Feeder for Birds”, which is hereby incorporated by reference in its entirety.

### FIELD OF THE INVENTION

The present invention relates to the field of bird feeders. Specifically, the present invention relates to bird feeders that may be attached to objects such as windows, used for bird watering and nectar feeding that may provide a close-up view of the bird for an observer viewing the feeder from inside their home.

### BACKGROUND

Window Nectar feeders for birds are well known in the art. Most window nectar feeders include a storage compartment or bottle, in which the liquid is stored, and a means of attaching the feeder to a window. In many cases, the window attachment and the feeder body are attached together or integrally formed. To clean the feeder or refill the storage compartment the user must completely detach the feeder from the window.

In the prior art, suction cups are used as a means of attaching the feeder to the window. However, detaching and reattaching the entire feeder is time consuming and in many cases the attachment strength of feeder deteriorates with each use until product failure.

In prior art, suction cups are used as a means of attaching the feeder to the window. Usually, the number of suction cups is two or less and in most cases the suction cups are set horizontally. As suction ability decreases due to outdoor weather and UV deterioration, the suction cups lose ability to maintain suction and the product falls off the window to the ground.

Therefore, need exists for novel bird feeder devices that overcome the above-mentioned disadvantages.

### BRIEF SUMMARY OF THE INVENTION

A novel bird fluid feeder device is disclosed which provides a solution to the problems associated with prior art. Preferably, the feeder may include a storage bottle that may be removably coupled to a base container and/or liquid tray and coupled to various objects via a holder bracket. The liquid in the storage bottle may be communicated into the liquid tray. One or more container apertures may be disposed in the container wall of the base container and each container aperture may removably receive an optional feed port. Preferably, the feed ports may be interchangeable and of various different colors. Birds may intake the liquid in the feed cavity of the liquid tray through the feed ports while resting on one or more perches that may be disposed on the base container. As shown in the attached figures, the device of the present invention includes a new and novel holder bracket that allows the user to clean and refill the storage bottle and other components with ease, without having to detach the whole device from the window or object to which it is attached.

In some embodiments, the device may include a storage bottle having a bottle cavity and a bottle base, and a liquid tray having a tray support wall and a feed cavity. A base container may be removably coupled to the liquid tray, the base container having a pass-through aperture and a container wall. The container wall may cover the feed cavity, and the bottle base may be received in the pass-through aperture and removably coupled to the tray support wall. At least one container aperture may be disposed in the container wall, and the container aperture may enable fluid communication through the container wall to the feed cavity. The device may further include a holder bracket having a first upper support arm, an arm brace, and a lower support arm. The arm brace may couple the first upper support arm to the lower support arm, and the storage bottle, base container, and liquid tray may be supported by the holder bracket by the first upper support arm contacting the storage bottle and by the lower support arm contacting the liquid tray. One or more fasteners may be coupled to the arm brace, and the fasteners may be configured to couple the holder bracket to an object.

In further embodiments, the device may include a storage bottle having a bottle cavity, a bottle support surface, and a bottle base, and a liquid tray having a tray wall, a channel, and a feed cavity, the tray wall defining a dispensing cavity, and the channel providing communication between the feed cavity and the dispensing cavity. A base container may be removably coupled to the liquid tray, the base container having a pass-through aperture, a container wall, a base support surface, and one or more container apertures. The container wall may cover the feed cavity, and the bottle base may be received in the pass-through aperture and removably coupled to the liquid tray. The bottle support surface may rest on the base support surface when the bottle is coupled to the liquid tray. Optionally, at least one feed port may be coupled to the container wall, and each feed port may be removably coupled to a container aperture. The feed ports and container apertures may enable fluid communication through the container wall to the feed cavity. The optional feed ports may function as trainer flowers, and may be removed from the container apertures once the birds get used to feeding at the feeder, such as to prevent mold growth and insects being attracted to the feed ports. The device may further include a holder bracket having a first upper support arm, an arm brace, and a lower support arm. The arm brace may couple the first upper support arm to the lower support arm, and the storage bottle, base container, and liquid tray may be supported by the holder bracket by the first upper support arm contacting the storage bottle and by the lower support arm contacting the liquid tray. One or more fasteners may be coupled to the arm brace and configured to couple the holder bracket to an object.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a perspective view of an example of a bird fluid feeder device according to various embodiments described herein.

FIG. 2 illustrates a perspective exploded view of an example of a bird fluid feeder device according to various embodiments described herein.

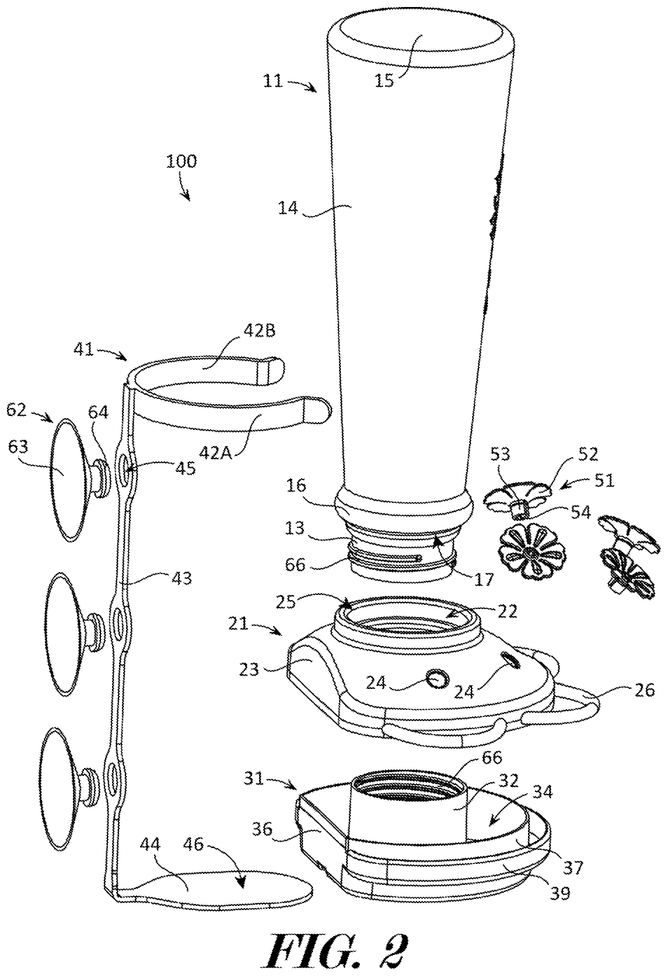

FIG. 3 shows a front elevation view of an example of a bird fluid feeder device according to various embodiments described herein.

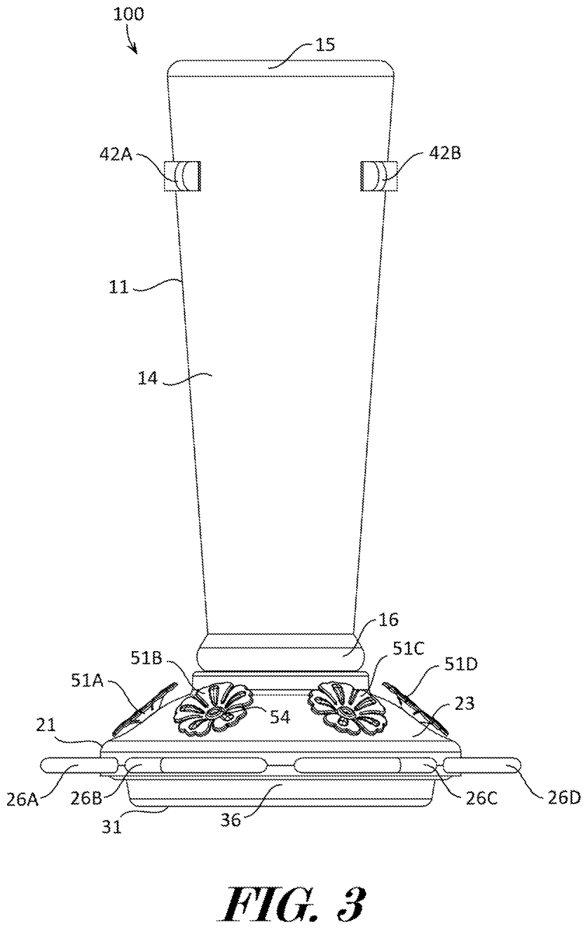

FIG. 4 depicts a rear elevation view of an example of a bird fluid feeder device according to various embodiments described herein.

FIG. 5 illustrates a bottom plan view showing an example of a liquid tray and base container according to various embodiments described herein.

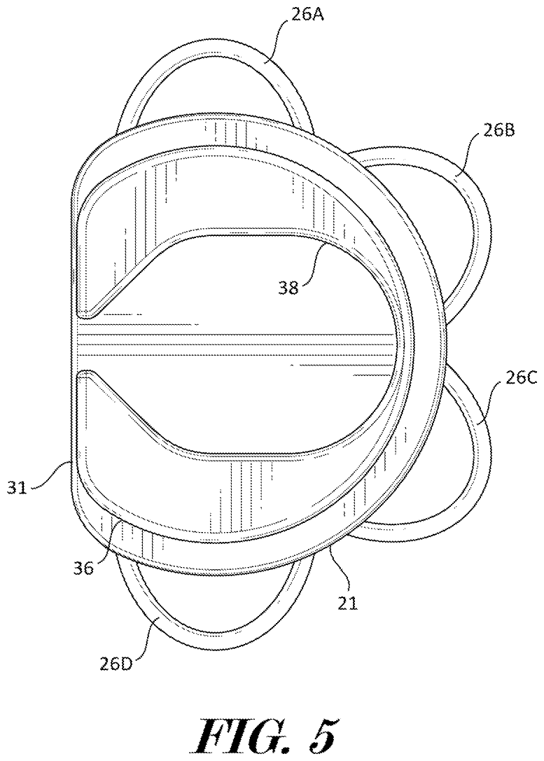

FIG. 6 shows a bottom plan view of the example liquid tray and base container of FIG. 5 with a lower support arm of a holder bracket received in an arm recess of the liquid tray according to various embodiments described herein.

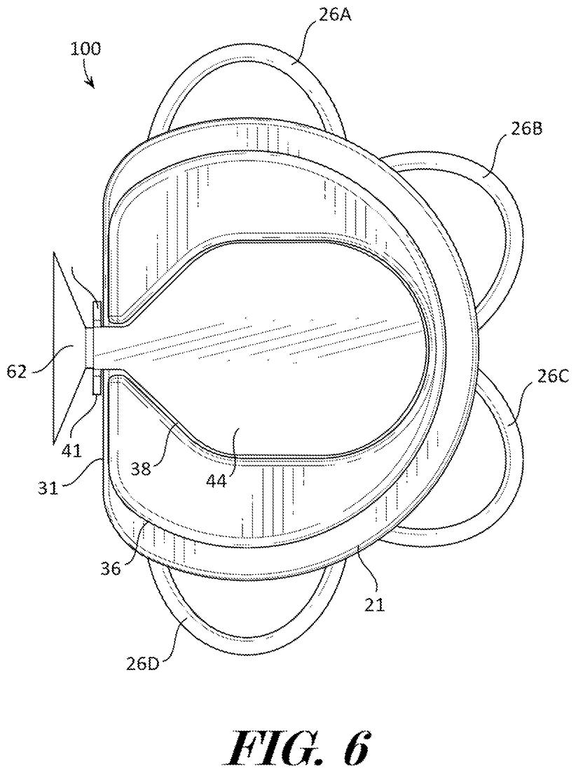

FIG. 7 depicts a top plan view of an example of a bird fluid feeder device according to various embodiments described herein.

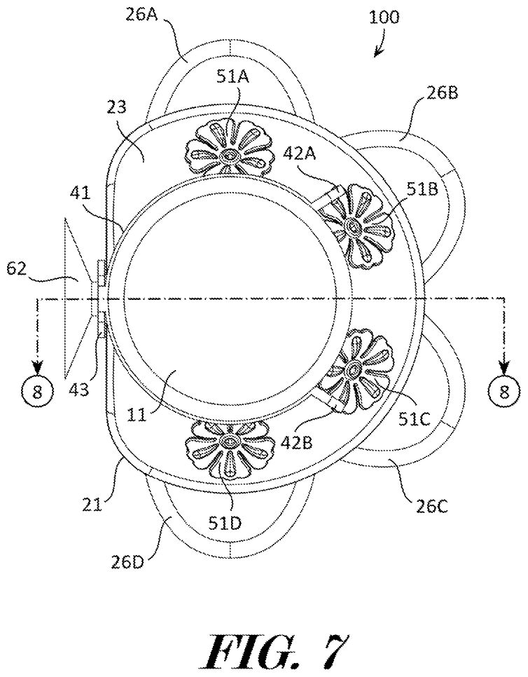

FIG. 8 illustrates a sectional, through line 8-8 shown in FIG. 7, elevation view of an example of a bird fluid feeder device according to various embodiments described herein.

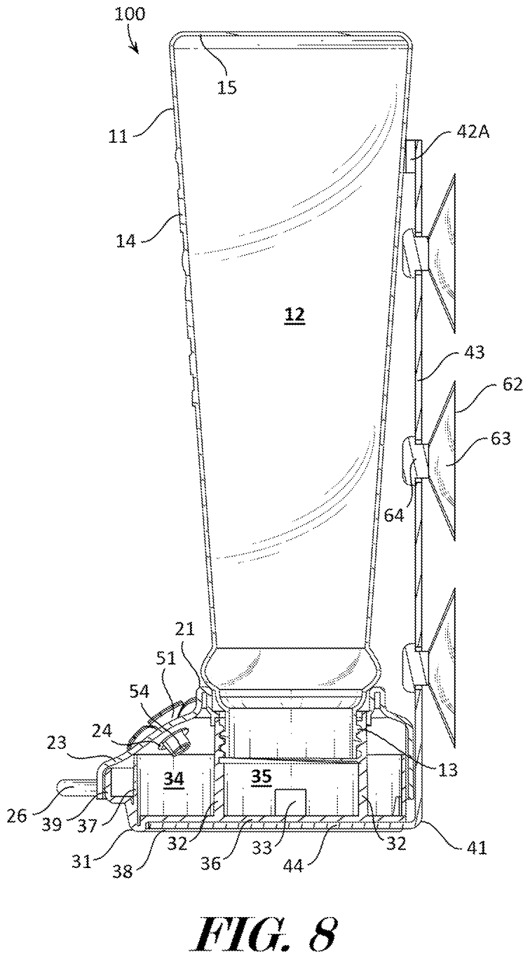

FIG. 9 shows a perspective view of an example of a holder bracket according to various embodiments described herein.

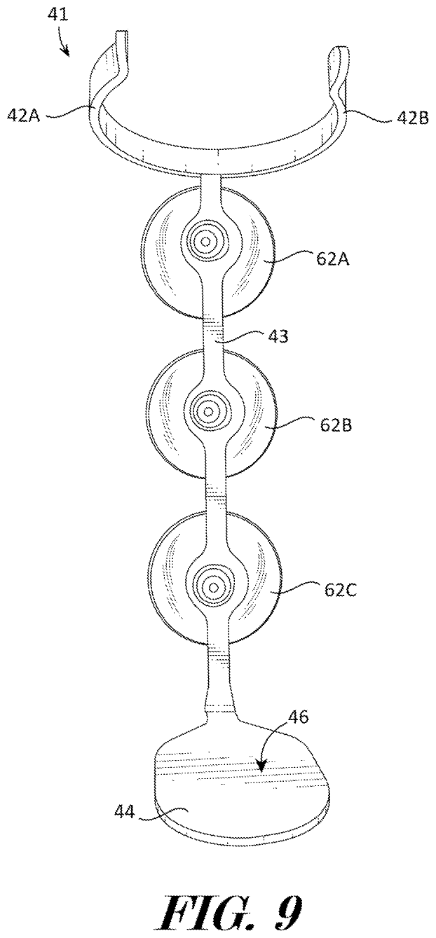

FIG. 10 depicts a perspective view of another example of a bird fluid feeder device according to various embodiments described herein.

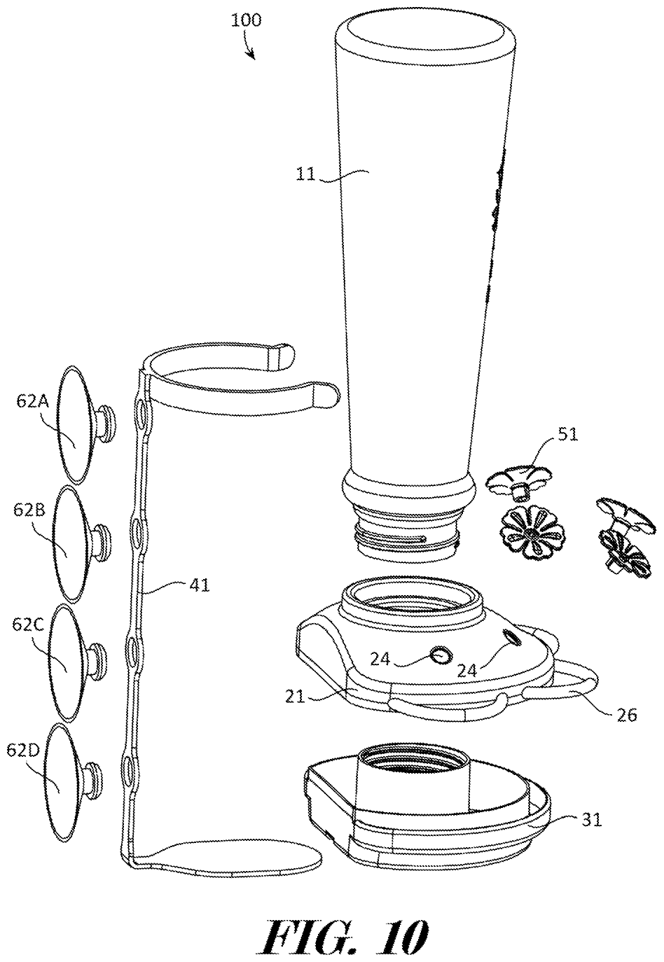

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

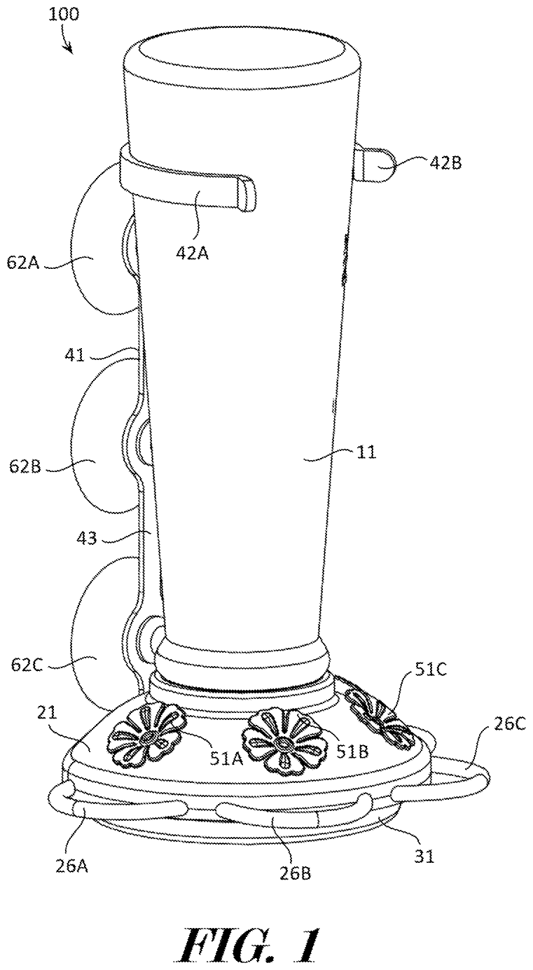

For purposes of description herein, the terms “upper,” “lower,” “left,” “right,” “rear,” “front,” “side,” “vertical,” “horizontal,” and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first,” “second,” etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

A new bird fluid feeder device is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

The present invention will now be described by example and through referencing the appended figures representing preferred and alternative embodiments. FIG. 1 illustrates an example of a bird fluid feeder device (“the device”) 100 according to various embodiments. In some embodiments, the device 100 may comprise a storage bottle 11, a base container 21, a liquid tray 31, and a holder bracket 41. The storage bottle 11 may have a bottle cavity 12 and a bottle base 13. The liquid tray 31 may have a tray support wall 32, a channel 33, and a feed cavity 34. The tray support wall 32 may define a dispensing cavity 35, and the channel 33 may provide communication between the feed cavity 34 and the dispensing cavity 35. The base container 21 may be removably coupled to the liquid tray 31, and the base container 21 may have a pass-through aperture 22 and a container wall 23. The container wall 23 may cover the feed cavity 34, and the bottle base 13 may be received in the pass-through aperture 22 and removably coupled to the liquid tray 31. One or more container apertures 24 may be disposed in the container wall 23, and the container apertures 24 may enable fluid communication through the container wall 23 to the feed cavity 34. The holder bracket 41 may have a first upper support arm 42A, an arm brace 43, and a lower support arm 44. The arm brace 43 may couple the first upper support arm 42A to the lower support arm 44, and the storage bottle 11, base container 21, and liquid tray 31 may be supported by the holder bracket 41 by the first upper support arm 42A contacting the storage bottle 11 and by the lower support arm 44 contacting the liquid tray 31. One or more fasteners 62 may be coupled to the arm brace 43, and the fasteners 62 may be configured to couple the holder bracket 41 to an object. Generally, a fluid bird feeding substance may be stored in the bottle cavity 12 and dispensed into the dispensing cavity 35 when the storage bottle 12 is coupled to the liquid tray 31. The fluid bird feeding substance may then be communicated into the feed cavity via the channel 33. A bird may then retrieve the fluid bird feeding substance through a container aperture 24, and optionally through a feed port 51 that may be coupled to the container aperture 24.

The device 100 may comprise a storage bottle 11 which may have a bottle cavity 12 which may be sized and shaped to hold a desired amount of a fluid bird feeding substance. The storage bottle 11 may include a bottle sidewall 14 which may be coupled to a bottle upper wall 15. The bottle base 13 may be formed by portions of the bottle sidewall 14 which may be most distal to the bottle upper wall 15. The bottle sidewall 14, bottle upper wall 15, and other elements of the storage bottle 11 may be configured in any size and shape. In preferred embodiments, one or more elements of the storage bottle 11 may comprise a substantially rigid and transparent or translucent material, such as glass, polycarbonate plastic, etc. In other embodiments, one or more elements of the storage bottle 11 may be made from or may comprise a substantially rigid material, such as steel alloys, aluminum, other types of metal or metal alloys, ceramics such as alumina, porcelain, and boron carbide, earthenware, natural stone, synthetic stone, various types of hard plastics, such as polyethylene (PE), Ultra-high-molecular-weight polyethylene (UHMWPE, UHMW), polypropylene (PP) and polyvinyl chloride (PVC), nylon, Poly(methyl methacrylate) (PMMA) also known as acrylic, melamine, hard rubbers, fiberglass, carbon fiber, resins, such as epoxy resin, wood, other plant based materials, or any other material including combinations of materials.

Optionally, the bottle sidewall 14 may comprise a bottle bevel 16 which may form a portion of the bottle sidewall 14 which may be beveled outwards compared to the portions of the bottle sidewall 14 that are adjacent to the bottle bevel 16. Preferably, the storage bottle 11 may comprise one or more bottle support surfaces 17 which may optionally be formed by the bottle bevel 16, and the one or more bottle support surfaces 17 may rest against, be tensioned against, or otherwise contact portions of the base container 21 when the storage bottle 11 is coupled to the liquid tray 31. In some embodiments, the bottle bevel 16 and a bottle support surface 17 formed by the bottle bevel 16 may be annular or ring shaped. In other embodiments, the bottle bevel 16 and one or more bottle support surfaces 17 formed by the bottle bevel 16 may be configured in any other shape and size.

The device 100 may comprise a liquid tray 31 which may receive a fluid bird feeding substance from the storage bottle 11 and hold the fluid bird feeding substance in a fluid bird feeding substance in a feed cavity 34 for retrieval by a bird through one or more feed ports 51. A liquid tray 31 may be configured in any size and shape. In preferred embodiments, a liquid tray 31 may comprise a tray base wall 36 to which a tray support wall 32 may be coupled. The liquid tray 31 may also comprise a perimeter wall 37 and an optional distal wall 39 which may also be coupled to the tray base wall 36 and which may extend around or surround the tray support wall 32. Both the tray support wall 32 and perimeter wall 37 may extend above the tray base wall 36.

In preferred embodiments, the tray support wall 32 may be generally cylindrical in shape and may be configured to be removably coupled to the bottle base 13 which may also be generally cylindrical in shape. In further preferred embodiments, the tray support wall 32 may be rotatably coupled to the bottle base 13, thereby allowing the storage bottle 11 to be rotatably coupled to liquid tray 31. In some embodiments, the device 100 may comprise threading 66 which may be disposed on the tray support wall 32 and bottle base 13 which may be used to rotatably couple the tray support wall 32 and bottle base 13 together. In further embodiments, the tray support wall 32 and bottle base 13 may be removably coupled together by being press fit or snap fit together, by one or more fasteners such as threaded type fasteners, sealable tongue and groove fasteners, snap fasteners, clip type fasteners, clasp type fasteners, a push-to-lock type connection method, a turn-to-lock type connection method, a slide-to-lock type connection method or any other suitable temporary connection method as one reasonably skilled in the art could envision to serve the same function.

The liquid tray 31 may comprise a dispensing cavity 35 which may be formed and bound by the tray base wall 36 and the tray support wall 32. When the storage bottle is coupled to the tray support wall 32, fluid bird feeding substance may be communicated from the bottle cavity 12 into the dispensing cavity 35. The liquid tray 31 may also comprise a feed cavity 34 from which fluid bird feeding substance may be retrieved by birds using the device 100. A feed cavity 34 may be formed and bound by the tray base wall 36 and the perimeter wall 37. The liquid tray 31 may include one or more channels 33 which may provide communication between the feed cavity 34 and the dispensing cavity 35 to allow fluid bird feeding substance in the dispensing cavity 35 to flow into the feed cavity 34. In other embodiments, the device 100 may comprise a single cavity or compartment which may perform the functions of a feed cavity 34 and the dispensing cavity 35.

Preferably, the liquid tray 31 may comprise one or more channels 33 which may be formed into a tray supporting wall 32. Generally, a channel 33 may comprise an opening, aperture, etc., which may allow a liquid, such as a fluid bird feeding substance, to pass through the channel 33 thereby enabling fluid communication between a feed cavity 34 and a dispensing cavity 35. A channel 33 may be configured in any size and shape, such as a rectangular opening, circular opening, etc.

The device 100 may comprise a base container 21 which may be removably coupled to the liquid tray 31 and/or storage bottle 11. In some embodiments, a base container 21 may include a pass-through aperture 22 and a container wall 23. A container wall 23 may be sized and shaped so that it may cover a feed cavity 34 and prevent access to the feed cavity 34.

The container wall 23 may be configured in any size and shape, and preferably configured to extend around a storage bottle 11 that may be coupled to the liquid tray 31 and to extend from the storage bottle 11, over the one or more feed cavities 34, and to or past the perimeter wall 37 so as to completely cover the one or more feed cavities 34. The container wall 23 may comprise one, two, three, four, five, six, or more container apertures 24 which may comprise an opening of any shape and size that may pass through the container wall 23 so that the one or more container apertures 24 enables fluid communication through the container wall 23 to the feed cavity 34.

The device 100 may optionally comprise one or more feed ports 51, such as a first feed port 51A, second feed port 51B, third feed port 51C, fourth feed port 51D, etc. The feed ports 51, 51A, 51B, 51C, 51D, may be coupled to the container wall 23, and each feed port 51 may enable fluid communication through the container wall 23 to the one or more feed cavities 34. The feed ports 51, 51A, 51B, 51C, 51D, may be configured in any shape and size. In preferred embodiments, a feed port 51, 51A, 51B, 51C, 51D, may comprise a cap 52 coupled to a body 53, and a port aperture 54 may extend through the cap 52 and body 53. The port aperture 54 may comprise an opening that extends through the feed port 51, 51A, 51B, 51C, 51D, and which may be sized and shaped to allow the beak of a humming bird to extend into and through the cap 52 and body 53. In this manner, when a feed port 51, 51A, 51B, 51C, 51D, is coupled to a base container 21, the port aperture 54 may provide fluid communication through the container wall 23 to the feed cavity 34 to allow the beak of a humming bird to extend through the feed port 51, 51A, 51B, 51C, 51D, and container wall 23 and into the feed cavity 34.

In preferred embodiments, a feed port 51, 51A, 51B, 51C, 51D, may comprise a cap 52 that may be shaped and configured to resemble a flower. In further preferred embodiments, the device 100 may comprise a plurality of feed ports 51, 51A, 51B, 51C, 51D, that may be interchangeably coupled to the container wall 23, and the feed ports 51, 51A, 51B, 51C, 51D, may comprise caps 52 of various different colors so that once the birds have learned where the feed ports 51, 51A, 51B, 51C, 51D, are, the user can change out the feed ports 51, 51A, 51B, 51C, 51D, to select feed ports 51, 51A, 51B, 51C, 51D, having a cap 52 with a color that prevents bees from infesting the device 100.

In some embodiments, the device 100 may comprise one or more feed ports 51, 51A, 51B, 51C, 51D, which may be generally non-removably coupled to the container wall 23. In preferred embodiments, the device 100 may comprise one or more feed ports 51, 51A, 51B, 51C, 51D, which may be removably coupled to the container wall 23. In further preferred embodiments, a container wall 23 may comprise one or more container apertures 24 which may be formed into the container wall 23 and which may form an opening into which portions of a feed port 51, 51A, 51B, 51C, 51D, may be inserted. Preferably, a feed port 51, 51A, 51B, 51C, 51D, may be removably coupled to the container aperture 24 and container wall 23 by inserting a portion of the body 53 into a container aperture 24, and the feed port 51, 51A, 51B, 51C, 51D, may be retained therein via a frictional fit. In other embodiments, a feed port 51, 51A, 51B, 51C, 51D, may be removably coupled to the container wall 23 by threading, magnetic fasteners, a turn-to-lock connection method, or any other removable coupling method.

In some embodiments, the base container 21 may comprise a pass-through aperture 22 formed in the container wall 23, and the bottle base 13 may be received in the pass-through aperture 22 when the storage bottle 11 is coupled to the liquid tray 31 thereby allowing the storage bottle to pass through the container wall 23. A pass-through aperture 22 may be configured in any size and shape.

In some embodiments, the base container 21 may comprise one or more base support surfaces 25 which may be positioned proximate to a pass-through aperture 22. Generally, a base support surface 25 may comprise a portion of the container wall 23 which may rest against, be tensioned against, or otherwise contact a portion of the storage bottle 11 when the storage bottle 11 is coupled to a liquid tray 31. In some embodiments, a base support surface 25 may be annular or ring shaped. In other embodiments, a base support surface 25 may be configured in any other shape and size. In preferred embodiments, the base container 21 may be removably coupled to the liquid tray 31 by a bottle support surface 17 pressing against or otherwise contacting a base support surface 24 when the bottle base 13 is received in the pass-through aperture 22 and removably coupled to the liquid tray 31.

In some embodiments, the base container 21 may comprise one or more perches 26, such as a first perch 26A, a second perch 26B, a third perch 26C, a fourth perch 26D, etc., which preferably may be coupled to the container wall 23, optionally to the liquid tray 31, and/or to any other element of the device 100. In preferred embodiments, a perch 26, 26A, 26B, 26C, 26D, may comprise a U-shape having two ends which are coupled to a container wall 23. In other embodiments, a perch 26, 26A, 26B, 26C, 26D, may comprise a post or elongated cylinder shape. However, it should be understood that a perch 26, 26A, 26B, 26C, 26D, may be configured in any size and shape which may allow one or more birds to rest on while feeding from a feed port 51, 51A, 51B, 51C, 51D. Preferably, the device 100 may comprise a number of perches 26, 26A, 26B, 26C, 26D, that may be equal to the number of feed ports 51, 51A, 51B, 51C, 51D.

The device 100 may comprise a holder bracket 41 which may be configured to couple the storage bottle 11, base container 21, and liquid tray 31 to various objects, such as windows. In preferred embodiments, a holder bracket 41 may comprise one or more upper support arms 42A, 42B, and a lower support arm 44 which may be coupled together via an arm brace 43.

An arm brace 43 may be configured in any shape and size. In preferred embodiments, an arm brace 43 may comprise an elongated shape which may be used to separate the one or more upper support arms 42A, 42B, and lower support arm 44 a desired distance from each other. In some embodiments, an arm brace 43 may comprise one or more brace apertures 45 which may be configured to receive and couple one or more fasteners 62 to the arm brace 43.

The device 100 may comprise one or more fasteners 62, such as a first fastener 62A, a second fastener 62B, a third fastener 62C, a fourth fastener 62D, etc. Generally, a fastener 62, 62A, 62B, 62C, 62D, may comprise a device for coupling the holder bracket 41 to an object. In preferred embodiments, a fastener 62, 62A, 62B, 62C, 62D, may comprise a suction cup, having a fastener cup 63 and a fastener base 64, which is a device or object that uses the negative fluid pressure of air or water to adhere to nonporous surfaces, creating a partial vacuum. Preferably, a portion of the fastener base 64 of a suction cup type fastener 62, 62A, 62B, 62C, 62D, may be press fit or otherwise coupled within a brace aperture 45 in order to couple the suction cup type fastener 62, 62A, 62B, 62C, 62D, to the arm brace 43. In other embodiments, a fastener 62, 62A, 62B, 62C, 62D, may comprise adhesive, a hook-and-loop type fastener, a screw, bolt, rivet, a magnetic fastener, or any other device which may be used to couple, and more preferably to removably couple the holder bracket 41 to an object.

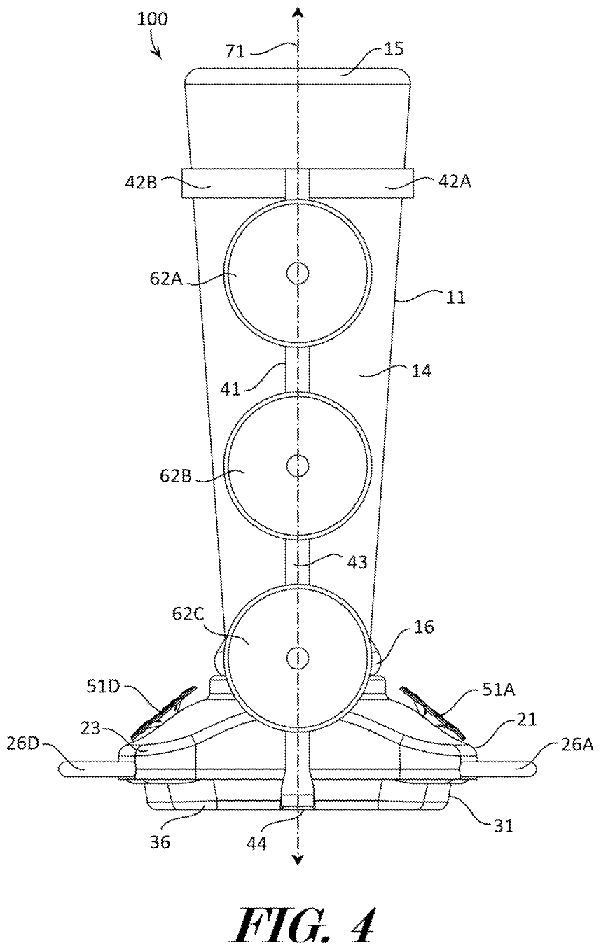

The device 100 may comprise any number of fasteners 62. In preferred embodiments, the device 100 may comprise at least two fasteners 62. In further preferred embodiments, the device 100 may comprise at least three fasteners 62 which may be coupled to the arm brace 43 so that at least three of the fasteners 62 are vertically aligned with each other as perhaps best shown by the vertical axis 71 intersecting with each of the fasteners 62 as shown in FIG. 4.

The holder bracket 41 may comprise one or more upper support arms, such as a first upper support arm 42A, a second upper support arm 42B, etc. Generally, an upper support arm 42A, 42B, may be coupled to an upper portion of the arm brace 43, and the upper support arm 42A, 42B, may be configured to contact and support or stabilize the storage bottle 11 when the storage bottle 11, base container 21, and liquid tray 31 are being supported by the holder bracket 41. In some embodiments, the holder bracket 41 may comprise a first upper support arm 42A which may rest against one side of the storage bottle 11. In further embodiments, the holder bracket 41 may comprise a first upper support arm 42A which may wrap around or encircle a portion of the storage bottle 11. In preferred embodiments, the holder bracket 41 may comprise a first upper support arm 42A which may rest against one side of the storage bottle 11 and a second upper support arm 42B which may rest against or otherwise contact an opposing side of the storage bottle 11 when the storage bottle 11 is coupled to the liquid tray 31 and being supported by the holder bracket 41.

Upper support arms 42A, 42B, may be configured in any size and shape. In some embodiments, the holder bracket 41 may comprise a first upper support arm 42A and a second upper support arm 42B which may contact opposing sides of the storage bottle 11, and the upper support arms 42A, 42B, may be configured to flex and tension against the opposing sides of the storage bottle 11. In this manner, the holder bracket 41 may be configured to grip portions of the storage bottle 11.

The holder bracket 41 may comprise a lower support arm 44 which may be coupled to a lower portion of an arm brace 43. In some embodiments an arm brace 43 and the one or more upper support arms 42A, 42B, may be coupled to opposing ends of the arm brace 43. Generally, a lower support arm 44 may support the liquid tray 31 so that the liquid tray 31 may rest on the liquid tray 31. In this manner, the storage bottle 11, base container 21, and liquid tray 31 may be supported by the holder bracket 41 by the upper support arm(s) 42A, 42B, contacting the storage bottle 11 and by the lower support arm 44 contacting the liquid tray 31.

In some embodiments, a lower support arm 44 may comprise one or more support surfaces 46 which the tray base wall 36 may rest on or contact when the liquid tray 31 is being supported by the holder bracket 41. In some embodiments, a lower support arm 44 may comprise a generally flat or planar shaped support surface 46. In further embodiments, a lower support arm 44 and its support surface 46 may be configured in any shape and size.

In some embodiments, the liquid tray 31 may comprise an arm recess 38 which may comprise a depression, recess, etc., in the tray base wall 36 which may be sized and shaped to receive all or portions of the lower support arm 44 and/or support surface 46. In preferred embodiments, an arm recess 38 may be complementary in shape to the shape of the one or more support surfaces 46 of the lower support arm 44 so that the ability of the one or more support surfaces 46 to move relative to the tray base wall 36 may be minimized.

While some exemplary shapes and sizes have been provided for elements of the device 100, it should be understood to one of ordinary skill in the art that the storage bottle 11, base container 21, liquid tray 31, holder bracket 41, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the device 100 may be made from or may comprise durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or may comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A bird fluid feeder device, the device comprising:
a storage bottle having a bottle cavity and a bottle base;
a liquid tray having a tray support wall and a feed cavity;
a base container removably coupled to the liquid tray, the base container having a pass-through aperture and a container wall, wherein the container wall covers the feed cavity, and wherein the bottle base is received in the pass-through aperture and removably coupled to the tray support wall;
at least one container aperture disposed in the container wall, wherein the at least one container aperture enables fluid communication through the container wall to the feed cavity;
a holder bracket having a first upper support arm, an arm brace, and a lower support arm, wherein the arm brace couples the first upper support arm to the lower support arm, and wherein the storage bottle, base container, and liquid tray are supported by the holder bracket by the first upper support arm contacting the storage bottle and by the lower support arm contacting the liquid tray; and
at least one fastener coupled to the arm brace, wherein the at least one fastener is configured to couple the holder bracket to an object.

2. The device of claim 1, further comprising a feed port that is removably coupled to the at least one container aperture.

3. The device of claim 1, further comprising a perch coupled to the container wall.

4. The device of claim 1, further comprising a second upper support arm coupled to the arm brace, wherein the first upper support arm and second upper support arm contact opposing sides of the storage bottle when the storage bottle is coupled to the liquid tray.

5. The device of claim 1, wherein the storage bottle is rotatably coupled to liquid tray.

6. The device of claim 1, wherein the at least one fastener is a suction cup.

7. The device of claim 1, further comprising at least three fasteners, wherein the at least three fasteners are vertically aligned with each other.

8. The device of claim 1, wherein the liquid tray has an arm recess, and wherein the lower support arm is received in the arm recess.

9. The device of claim 1, wherein the base container has a base support surface, wherein the storage bottle has a bottle support surface, and wherein the bottle support surface rests on the base support surface when the bottle is coupled to the liquid tray.

10. The device of claim 9, wherein the base support surface is annular in shape, and wherein the bottle support surface is annular in shape.

11. The device of claim 9, wherein the base container is removably coupled to the liquid tray by the bottle support surface pressing against the base support surface when the bottle base is received in the pass-through aperture and removably coupled to the liquid tray.

12. A bird fluid feeder device, the device comprising:
a storage bottle having a bottle cavity, a bottle support surface, and a bottle base;
a liquid tray having a tray wall, a channel, and a feed cavity, the tray wall defining a dispensing cavity, and the channel providing communication between the feed cavity and the dispensing cavity;
a base container removably coupled to the liquid tray, the base container having a pass-through aperture, a container wall, a base support surface, and at least one container aperture, wherein the container wall covers the feed cavity, and wherein the bottle base is received in the pass-through aperture and removably coupled to the liquid tray, and wherein the bottle support surface rests on the base support surface when the bottle is coupled to the liquid tray;
at least one feed port coupled to the container wall, wherein the at least one feed port is removably coupled to the at least one container aperture, and wherein the at least one container aperture and the at least one feed port enables fluid communication through the container wall to the feed cavity;
a holder bracket having a first upper support arm, an arm brace, and a lower support arm, wherein the arm brace couples the first upper support arm to the lower support arm, and wherein the storage bottle, base container, and liquid tray are supported by the holder bracket by the first upper support arm contacting the storage bottle and by the lower support arm contacting the liquid tray; and
at least one fastener coupled to the arm brace and configured to couple the holder bracket to an object.

13. The device of claim 12, further comprising a perch coupled to the container wall.

14. The device of claim 12, further comprising a second upper support arm coupled to the arm brace, wherein the first upper support arm and second upper support arm contact opposing sides of the storage bottle when the storage bottle is coupled to the liquid tray.

15. The device of claim 12, wherein the storage bottle is rotatably coupled to liquid tray.

16. The device of claim 12, wherein the at least one fastener is a suction cup.

17. The device of claim 12, further comprising at least three fasteners, wherein the at least three fasteners are vertically aligned with each other.

18. The device of claim 12, wherein the liquid tray has an arm recess, and wherein the lower support arm is received in the arm recess.

19. The device of claim 12, wherein the base container is removably coupled to the liquid tray by the bottle support surface pressing against the base support surface when the bottle base is received in the pass-through aperture and removably coupled to the liquid tray.

20. The device of claim 12, wherein the base support surface is annular in shape, and wherein the bottle support surface is annular in shape.
